(19) United States
(12) Patent Application Publication
(10) Pub. No.: US 2005/0104593 A1
(43) Pub. Date: May 19, 2005

(54) Nuclear quadrupole resonance detection system using a high temperature superconductor self-resonant coil

(76) Inventor: Daniel B. Laubacher, Wilmington (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/909,730

(22) Filed: Aug. 2, 2004

Related U.S. Application Data
(60) Provisional application No. 60/496,848, filed on Aug. 21, 2003.

(51) Int. Cl. G01V 3/00

(52) U.S. Cl. 324/322; 324/318

(57) ABSTRACT

The use of a high temperature superconductor self-resonant receive coil or transmit and receive coil that is coupled through mutual inductance to the receiver front-end of a nuclear quadrupole resonance system results in improved performance.

This application claims the benefit of U.S. Provisional Application No. 60/496,848, filed Aug. 21, 2003, which is incorporated in its entirety as a part hereof for all purposes.

### FIELD OF THE INVENTION

This invention relates to a nuclear quadrupole resonance detection system and the use of a high temperature superconductor self-resonant receive coil or transmit and receive coil that is coupled through mutual inductance to the receiver front-end.

### BACKGROUND OF THE INVENTION

The use of nuclear quadrupole resonance (NQR) as a means of detecting explosives and other contraband has been recognized for some time, see e.g. A. N. Garroway et al, IEEE Trans. on Geoscience and Remote Sensing, 39, pp. 1108-1118 (2001). NQR provides some distinct advantages over other detection methods. NQR requires no external magnet such as required by nuclear magnetic resonance. NQR is sensitive to the compounds of interest, i.e. there is a specificity of the NQR frequencies.

An NQR detection system can have separate transmit and receive coils. Alternatively and more typically, the same coil is used to transmit and receive. A transmit and receive coil of the NQR detection system provides a radio frequency (RF) magnetic field that excites the quadrupole nuclei in the sample and results in their producing their characteristic resonance signals that the coil receives. The NQR signals have low intensity and short duration. The transmit and receive coil is preferably tunable and has a high quality factor (Q). After transmitting the RF signal, the coil must have a rapid recovery time in order to detect the low intensity NQR signal. In view of the low intensity NQR signal, it is important to have a signal-to-noise ratio (S/N) as large as possible.

The sample 1 and the front-end 2 of a typical NQR detection system receiver are shown in FIG. 1. The magnetic fields of the NQR signal of sample 1 which couple to the receive or transmit and receive coil are represented by the current source 4 and the coil 5, wherein the receive coil, which can also be a transmit and receive coil, 3 and the coil 5 are coupled by mutual inductance. The receive coil 3 is wired to and part of the receiver front-end 2. Also shown as a portion of the NQR detection system receiver front-end 2 are a capacitor 6, a reactance 7 that is usually an inductance, a capacitance or a combination of both and a first-stage amplifier 8.

The receive coil 3 has typically been a copper coil and therefore has a Q of about 10². It is advantageous to use a receive coil or a transmit and receive coil made of a high temperature superconductor rather than copper since the HTS self-resonant coil has a Q of the order of 10³-10⁶.

An object of the present invention is to provide a way of using a high temperature superconductor (HTS) self-resonant receive coil or transmit and receive coil in an optimum configuration with respect to the receiver front-end.

### SUMMARY OF THE INVENTION

This invention provides a nuclear quadrupole resonance detection system comprising a high temperature superconductor self-resonant receive coil or transmit and receive coil, wherein the high temperature superconductor self-resonant receive coil or transmit and receive coil is coupled through mutual inductance to the receiver front-end of the nuclear quadrupole resonance detection system. Preferably, the high temperature superconductor self-resonant receive coil or transmit and receive coil is a planar or surface coil.

This detection system is especially useful for detecting contraband.

### BRIEF DESCRIPTION OF THE DRAWINGS

FIG. 1 shows a typical NQR detection system receiver front-end.

FIG. 2 shows a NQR detection system receiver front-end with the mutual inductive coupling of the invention.

### DETAILED DESCRIPTION OF THE PREFERRED EMBODIMENTS

This invention relates to a NQR detection system that has a high temperature superconductor self-resonant receive coil or transmit and receive coil that is coupled through mutual inductance to the receiver front-end.

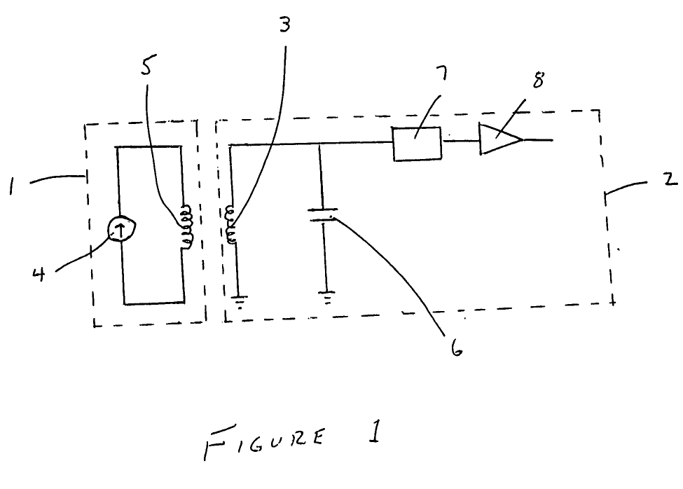

The manner in which the HTS coil is used is important for producing the optimum improvement in performance that can be achieved with the HTS coil. The signal-to-noise ratio (S/N) is proportional to the square root of the Q of the receiver front-end. When copper or another metal is used for the receive coil or the transmit and receive coil, the arrangement for coupling from the sample to the receiver front-end is as shown in FIG. 1 and discussed above. The unloaded Q of the circuit is dominated by the resistive losses in the copper coil, and is not appreciably affected by the resistive losses in the short wires connecting the coil to the first stage of amplification.

The use of a HTS self-resonant receive coil or transmit and receive coil can provide significant advantage over the conventionally used copper coil. The advantage arises from the high Q of the HTS self-resonant coil with Q's the order of 10³-10⁶ compared to the typical Q of 10² for a copper coil. If used in the same manner as the copper coil, i.e. wired to the receiver front-end as shown in FIG. 1, the HTS receive coil or transmit and receive coil would only slightly improve the Q of the receiver front-end. However, if used as a self-resonant coil and optimally coupled to the receiver front-end, the HTS self-resonant receive coil or transmit and receive coil can result in the significantly higher Q's inherent with the coil.

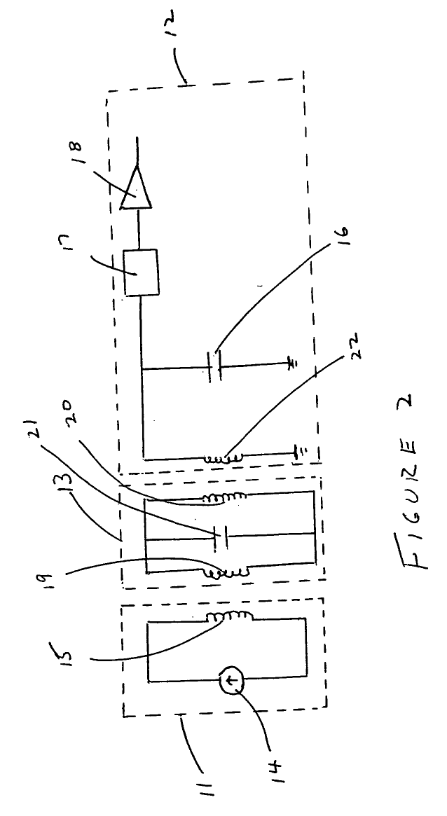

FIG. 2 shows a NQR detection system receiver front-end with the mutual inductive coupling of the invention. The sample 11 and the front-end 12 of a NQR detection system receiver are shown in FIG. 2 along with the HTS self-resonant receive coil or transmit and receive coil 13. The magnetic fields of the NQR signal of sample 11 which couple to the HTS self-resonance receive coil or transmit and receive coil 13 are represented by the current source 14 and the coil 15, wherein the HTS self-resonant receive coil or transmit and receive coil 13 and the coil 15 are coupled by mutual inductance. The HTS self-resonant receive coil or transmit and receive coil 13 is represented by the two coils 19 and 20 and a capacitor 21. The HTS self-resonant receive coil or transmit and receive coil 13 is coupled through mutual inductance to the receiver front-end 12 through the coil 22. No wires directly couple the HTS self-resonant receive coil or transmit and receive coil 13 to the receiver front-end 12.

Also shown as a portion of the NQR detection system receiver front-end 12 are a capacitor 16, a reactance 17 that is usually an inductance, a capacitance or combination of both and an amplifier 18. The coupling of the HTS self-resonant receive coil or transmit and receive coil to the receiver front-end can be adjusted so that the input impedance of the system provides the maximum signal-to-noise performance. Varying the magnitudes of capacitor 16 and the reactance 17 provide one way for accomplishing impedance matching. However, these components should be viewed as an equivalent circuit for impedance matching that can be carried out by other means. For example, impedance matching can be accomplished by physically changing the distance between the receive or transmit and receive coil 13 and coil 22 of the receiver front-end 12.

High temperature superconductors are those that superconduct above 77K. The high temperature superconductors used to form the HTS self-resonant receive coil or transmit and receive coil is preferably selected from the group consisting of YBa₂Cu₃O₇, Tl₂Ba₂CaCu₂O₈, TlBa₂Ca₂Cu₃O₉, (TlPb) Sr₂CaCu₂O₇ and (TlPb)Sr₂Ca₂Cu₃O₉. Most preferably, the high temperature superconductor is Tl₂Ba₂CaCu₂O₈ or YBa₂Cu₃O₇.

The HTS self-resonant receive coil or transmit and receive coil can be formed by various known techniques. A planar coil can be formed on just one side of a substrate. Preferably, however, a planar coil is formed on both sides of a substrate by first depositing HTS layers on both sides of a single crystal substrate. In a preferred technique, the HTS layers are formed directly on a single crystal LaAlO₃ substrate or on a CeO₂ buffer layer on a single crystal sapphire (Al₂O₃) substrate. An amorphous precursor layer of Ba:Ca:Cu oxide about 500 nm thick and with a stoichiometry of about 2:1:2 is deposited by off-axis magnetron sputtering from a Ba:Ca:Cu oxide target. The precursor film is then thallinated by annealing it in air for about 45 minutes at 850° C. in the presence of a powder mixture of Tl₂Ba₂Ca₂Cu₃O₁₀ and Tl₂O₃. When this powder mixture is heated, Tl₂O evolves from the powder mixture, diffuses to the precursor film and reacts with it to form the Tl₂Ba₂CaCu₂O₈ phase. The sample is then coated with photoresist on both sides and baked.

A coil design mask is prepared. The design mask is then centered on the photoresist covering the Tl₂Ba₂CaCu₂O₈ film on the front side of the substrate and exposed to ultraviolet light. If the coil is to have the same HTS pattern on both sides of the substrate, the design mask is then centered on the photoresist covering the Tl₂Ba₂CaCu₂O₈ film on the back side of the substrate and exposed to ultraviolet light. The resist is then developed on both sides of the substrate and the portion of the Tl₂Ba₂CaCu₂O₈ film exposed when the resist is developed is etched away by argon beam etching. The remaining photoresist layer is then removed by an oxygen plasma. The result is the desired HTS self-resonant receive coil or transmit and receive coil.

An NQR detection system according to this invention can be used to detect the presence of chemical compounds for any purpose, but is particularly useful for detecting the presence of controlled substances such as explosives, drugs or contraband of any kind. Such an NQR detection system could be usefully incorporated into a safety system, a security system, or a law enforcement screening system. For example, these systems can be used to scan persons and their clothing, carry-on articles, luggage, cargo, mail and/or vehicles. They can also be used to monitor quality control, to monitor air or water quality, and to detect biological materials.

Where an apparatus or method of this invention is stated or described as comprising, including, containing, having, being composed of or being constituted by certain components or steps, it is to be understood, unless the statement or description explicitly provides to the contrary, that one or more components or steps other than those explicitly stated or described may be present in the apparatus or method. In an alternative embodiment, however, the apparatus or method of this invention may be stated or described as consisting essentially of certain components or steps, in which embodiment components or steps that would materially alter the principle of operation or the distinguishing characteristics of the apparatus or method would not be present therein. In a further alternative embodiment, the apparatus or method of this invention may be stated or described as consisting of certain components or steps, in which embodiment components or steps other than those as stated would not be present therein.

Where the indefinite article “a” or “an” is used with respect to a statement or description of the presence of a component in an apparatus, or a step in a method, of this invention, it is to be understood, unless the statement or description explicitly provides to the contrary, that the use of such indefinite article does not limit the presence of the component in the apparatus, or of the step in the method, to one in number.

1. A nuclear quadrupole resonance detection system comprising a high temperature superconductor self-resonant transmit and receive coil and a receiver front-end, wherein the high temperature superconductor self-resonant transmit and receive coil is coupled through mutual inductance to the receiver front-end.

2. The nuclear quadrupole resonance detection system of claim 1 wherein the high temperature superconductor self-resonant transmit and receive coil is a planar coil.

3. The nuclear quadrupole resonance detection system of claim 1 wherein the coupling of the high temperature superconductor self-resonant transmit and receive coil to the receiver front-end is adjusted to provide impedance matching.

4. The nuclear quadrupole resonance detection system of any of claims 1-3 wherein the high temperature superconductor is selected from the group consisting of YBa₂Cu₃O₇, Tl₂Ba₂CaCu₂O₈, TlBa₂Ca₂Cu₃O₉, (TlPb)Sr₂CaCu₂O₇ and (TlPb)Sr₂Ca₂Cu₃O₉.

5. The nuclear quadrupole resonance detection system of claim 4 wherein the high temperature superconductor is Tl₂Ba₂CaCu₂O₈.

6. The nuclear quadrupole resonance detection system of claim 4 wherein the high temperature superconductor is YBa₂Cu₃O₇.

7. A nuclear quadrupole resonance detection system comprising a high temperature superconductor self-resonant receive coil and a receiver front-end, wherein the high temperature superconductor self-resonant receive coil is coupled through mutual inductance to the receiver front-end.

8. The nuclear quadrupole resonance detection system of claim 7 wherein the high temperature superconductor self-resonant receive coil is a planar coil.

9. The nuclear quadrupole resonance detection system of claim 7 wherein the coupling of the high temperature superconductor self-resonant receive coil to the receiver front-end is adjusted to provide impedance matching.

10. The nuclear quadrupole resonance detection system of any of claims 7-9 wherein the high temperature superconductor is selected from the group consisting of YBa₂Cu₃O₇, Tl₂Ba₂CaCu₂O₈, TlBa₂Ca₂Cu₃O₉, (TlPb)Sr₂CaCu₂O₇ and (TlPb)Sr₂Ca₂Cu₃O₉.

11. The nuclear quadrupole resonance detection system of claim 10 wherein the high temperature superconductor is Tl₂Ba₂CaCu₂O₈.

12. The nuclear quadrupole resonance detection system of claim 10 wherein the high temperature superconductor is YBa₂Cu₃O₇.

13. A safety system, security system, or law enforcement screening system comprising a nuclear quadrupole resonance detection system according to claims 1 and 7.
